(19) United States
(12) Patent Application Publication
(10) Pub. No.: US 2003/0038259 A1
(43) Pub. Date: Feb. 27, 2003

(54) Valve for controlling liquids

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/129,610

(22) PCT Filed: May 25, 2001
(86) PCT No.: PCT/DE01/02027

(30) Foreign Application Priority Data
Sep. 8, 2000 (DE) 100 44 389.3

(51) Int. Cl. F16K 31/02

(52) U.S. Cl. 251/129.06; 251/129.2

(57) ABSTRACT

The current invention relates to a fluid control valve. The valve includes a piezoelectric actuator (2), a stroke increasing mechanism (3), which increases the stroke of the piezoelectric actuator (2), a restoring element (4), and a valve element (5). The stroke increasing mechanism is embodied as a tilting lever (3) and the valve element (5) is integrated into the tilting lever, which achieves a high degree of system rigidity with a minimum number of parts.

### PRIOR ART

The invention relates to a fluid control valve as generically defined by the preamble to claim 1.

Fluid control valves are known in numerous embodiments. For example, U.S. Pat. No. 4,022,166 has disclosed a piezoelectric fuel injection valve, in which the valve number is controlled by means of a piezoelectric element. The stroke of the piezoelectric element is transmitted directly to the valve needle by means of a lever. In addition, two restoring springs are provided in order to hold the valve needle and the lever in their respective initial positions. This design with two restoring springs, which are connected to each other by means of the lever, results in a very oscillation-sensitive structure, which is particularly unsuitable for a high-pressure injection since the oscillations can build up.

The prior art also includes injectors, which use hydraulic stroke increasing mechanisms in order to increase the stroke of a piezoelectric actuator. However, embodiments of this kind are generally relatively complex in design and are comprised of a large number of parts. Since the piezoelectric actuators are only capable of producing a very small stroke, the known mechanical or hydraulic stroke increasing mechanisms are relatively complex.

### ADVANTAGES OF THE INVENTION

The fluid control valve according to the invention, with the characterizing features of claim 1, has the advantage over the prior art that it is simple in design and inexpensive to produce. Because the stroke increasing mechanism is embodied in the form of a tilting lever and the valve element is integrated into the tilting lever, the fluid control valve according to invention has only a small number of components. This lends the valve according to the invention a particularly compact design. This produces a maximal rigidity of the system from the actuator to the valve seat, with a minimal number of contact surfaces between the individual components. Furthermore, possibly occurring stroke tolerances of the system can be compensated for by means of the stroke increasing function. Since the stroke increasing mechanism is disposed in a fuel-filled chamber in the valve, this produces a favorable lubrication, which results in a reduced wear.

According to a preferred embodiment of the current invention, the tilting lever and the valve element are embodied of one piece. In other words, the valve element is integrated directly into the tilting lever. This minimizes the number of individual components since a separate valve element is not required. The region of the tilting lever, which serves as a valve element, can therefore have an arbitrary geometric form. In this connection, care must only be taken that there be sufficient sealing properties at the valve seat. For example, the region of the tilting lever serving as the valve element can be embodied in a hemispherical or conical form.

According to another preferred embodiment of the current invention, the valve element is embodied a separate ball, which can be actuated by the tilting lever.

Preferably, the tilting lever is provided with a recess for containing the valve element. The recess can either be embodied so that the valve element is contained tightly in the recess (e.g. by means of a press fit) or embodied so that the valve element is contained loosely in the recess. If the valve element is contained loosely in the recess, steps must naturally be taken to assure that during the opening of the valve, the path of the tilting lever is limited so that the loose valve element cannot be lost.

Preferably, the restoring element engages the tilting lever directly. Preferably, a spring, e.g. the helical spring, is used as the restoring element. In a particularly preferable embodiment, a spring seat is embodied in the tilting lever. This spring seat can be embodied, for example, by means of a recess, which is provided in the tilting lever and contains one end of the spring.

In order to give the stroke increasing mechanism, which is embodied as a tilting lever, as little play as possible, the stroke increasing mechanism is preferably disposed in a guide bush. The stroke increasing mechanism is then guided in this guide bush during operation. In this instance, the guide bush can be easily prefabricated with very low component tolerances. Consequently, the stroke increasing mechanism has only a minimal amount of play, which lends the entire system a maximal amount of rigidity.

According to another preferred embodiment of the current invention, the valve element is embodied as a double seat valve. Preferably, the two seats are embodied at one lever end of the tilting lever. In this connection, the valve can be embodied in such a way that it can assume three positions, namely a first position in which the valve element rests against the first valve seat and closes it, a second position in which the valve element rests against the second valve seat and closes it, and a third position in which the valve element rests against neither of the valve seats so that both valve seats are open (middle position).

Preferably, the tilting lever is connected to the piezoelectric actuator by means of a tension band. This permits the valve to be simply held in the middle position.

In order to integrate the valve element simply into the tilting lever in a double seat valve, the tilting lever is preferably provided with a through opening, which contains a separate valve element, for example a ball.

Preferably, the fluid control valve according to the invention is used in an injection device for a common rail system. In a particularly preferred embodiment, it is used as a control valve of an injector.

The invention consequently produces a fluid control valve, whose small number of components results in a compact design and a maximal rigidity of the system. As a result, the injection process can be more precisely executed and further improved, particularly with regard to the fuel injection that takes place in accumulator fuel injection systems.

### DRAWINGS

Several exemplary embodiments of the invention will be explained in detail in the subsequent description.

FIG. 1 shows a schematic, partially sectional view of a control valve for a fuel injection valve according to a first exemplary embodiment of the current invention;

FIG. 2 shows a schematic, partially sectional view of a control valve for a fuel injection valve according to a second exemplary embodiment of the current invention;

FIG. 3 shows a schematic, partially sectional view of a control valve for a fuel injection valve according to a third exemplary embodiment of the current invention;

FIG. 4 shows a schematic, partially cross-sectional view of a control valve for a fuel injection valve according to a fourth exemplary embodiment of the current invention;

FIG. 5 graphically depicts the nozzle position of the fuel injection valve depending on the control valve, and

FIG. 6 graphically plots the position of the control valve shown in FIG. 4 over time.

### DESCRIPTION OF THE EXEMPLARY EMBODIMENTS

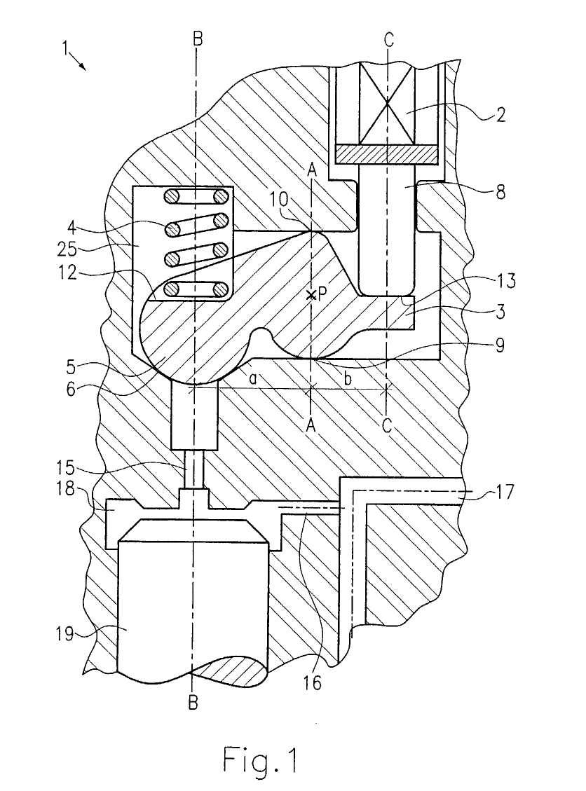

FIG. 1 shows a control valve for a fuel injection valve in a common rail system. As is shown in FIG. 1, the control valve 1 includes a piezoelectric actuator 2, a mechanical stroke increasing mechanism embodied as a tilting lever 3, and a helical spring 4 used as a restoring element. The tilting lever here is disposed in a chamber 25 in the valve.

As is shown in FIG. 1, the tilting lever 3 has a hemispherical region 5, which is embodied as a valve element. The hemispherical region 5 here closes a valve seat 6. The tilting lever 3 is rotatably supported at two points, namely a first support 9 and a second support 10. In this connection, the tilting lever 3 rotates around an imaginary point P, which is disposed at the midpoint between the two bearing points 9 and 10. In addition, the tilting lever 3 has a contact surface 13 against which a piston 8 rests, which is connected to the piezoelectric actuator 2. The region 5 of the tilting lever 3 closes an outlet from a control chamber 18, which contains a control piston 19. The control piston 19 is directly or indirectly connected to a valve needle of the fuel injection valve in order to open or close this fuel injection valve. A fuel supply line 17 is connected to the control chamber 18 by means of a throttle 16.

Since the piezoelectric actuator 2 executes only a very small stroke, this stroke is increased as it is transmitted to the tilting lever 3 by the piston 8. The stroke increase ratio of the tilting lever is a:b, where a represents the length of the lever arm between a line A-A through the bearing points 9 and 10 and a center line B-B for a bore to the control chamber 18, which is opened and closed by the region 5 of the tilting lever 3. The length b is the distance between the axis A-A and an axis C-C, which constitutes the center line of the piston 8, which presses against the tilting lever 3.

The function of the control valve according to the first exemplary embodiment will be described below. When highly pressurized fuel, which is supplied to an injection needle of the injector via the supply line 17, is to be injected, the piezoelectric actuator 2 is activated so that it executes a stroke in the direction of the piston. This stroke of the piezoelectric actuator 2 is transmitted to the to the first lever b of the tilting lever 3 by means of the piston 8. As a result, the tilting lever 3 rotates around the point P on the axis A-A so that the region 5 of the tilting lever is lifted up from the valve seat 6 counter to the force of the helical spring 4. This produces a connection from the control chamber 18, via a throttle 15 to the chamber 25, which contains the tilting lever. The throttle 16 likewise connects the control chamber 18 to the fuel supply line 17. If the control valve is open, then the fuel flows via the throttle 15 into the chamber 25. As a result, the pressure in the vicinity of the control chamber 18 drops, which causes the control piston 19 to move toward the tilting lever 3. Consequently, the valve needle of the injector lifts up from its seat so that fuel is injected into a combustion chamber.

When the piezoelectric actuator 2 is deactivated, the tilting lever 3 is moved back into its initial position by the restoring spring 4 so that the region 5 of the tilting lever 3 once again rests against the valve seat 6. As a result, the pressure in the vicinity of the control chamber 18 increases again, which moves the control piston 19 in the opposite direction. This causes the valve needle to seal the seat of the injector again and the fuel injection is terminated.

The integral embodiment of the tilting lever with the region 5, which acts as a valve element that the opens and closes the valve seat 6, produces a very compact design with few components. In addition, the control valve can be produced as a very rigid system so that in particular, the injection precision can be improved in comparison with the prior art.

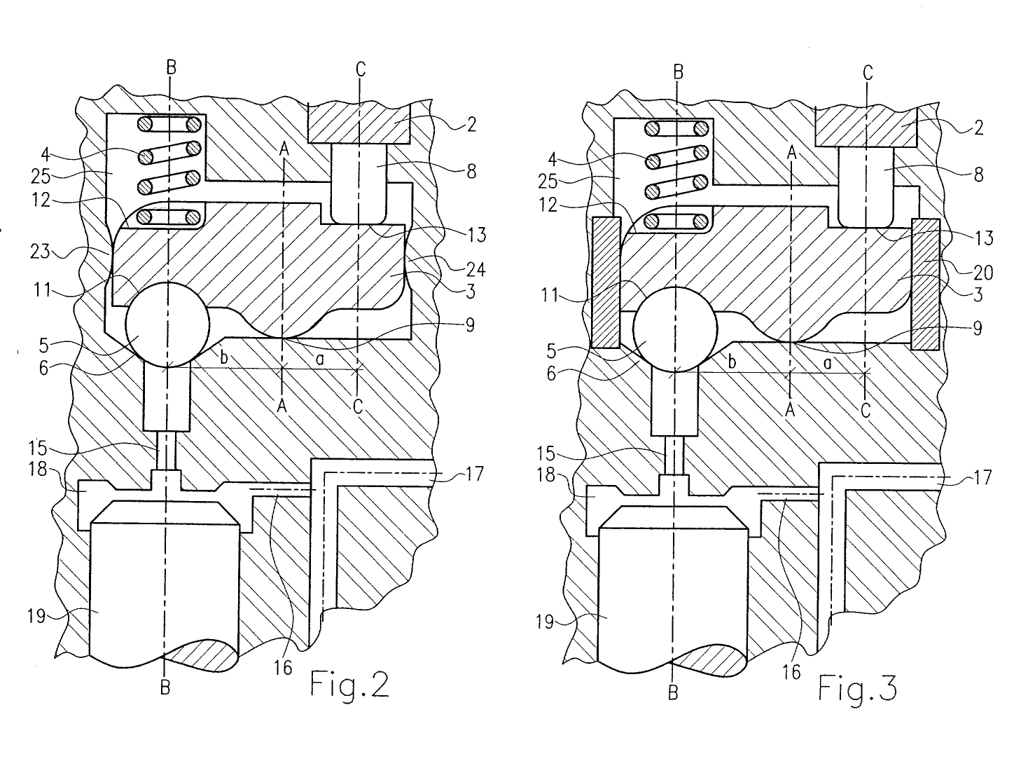

FIG. 2 shows a second exemplary embodiment of a control valve for an injector for injecting fuel. Parts that are the same or that function in the same manner have been provided with the same reference numerals as in the first exemplary embodiment. Since the second exemplary embodiment corresponds to a large extent with the first exemplary embodiment, only the differences will be explained in detail below.

In contrast with the first exemplary embodiment, the tilting lever 3 of the second exemplary embodiment is designed with a recess 11, which contains a separate valve element 5. As is shown in FIG. 2, the valve element is embodied as a valve ball 5. The valve ball 5 is loosely contained in the recess 11 of the tilting lever 3.

As is also shown in FIG. 2, the tilting lever 3 is supported on only one bearing point 9. Consequently, the fulcrum of the tilting lever 9 is disposed in the contact region of the bearing point 9 with the tilting lever 3 on the line A-A.

In order to increase the rigidity system, two protruding bulges 23 and 24 are embodied on the side walls of the chamber 25 for containing the tilting lever, and the tilting lever 3 is disposed between these bulges. These bulges 23 and 24 serve to guide the tilting lever 3 and further increase the rigidity of the system. The lever ratio of the tilting lever 3 is determined by the length of the two arms a:b and can be changed depending on the intended use by changing the lever arm lengths. To do so requires only the installation of a different tilting lever element 3 in the injector, whose bearing point 9 is shifted to the left or right.

The function of the injector shown in FIG. 2 corresponds essentially to the function of the injector of the first exemplary embodiment so that reference can be made to the description in the first exemplary embodiment.

FIG. 3 shows a control valve for an injector for injecting fuel according to a third exemplary embodiment of the current invention. Parts that are the same or that function in the same manner have been provided with the same reference numerals as in the two embodiments described above. Since the third exemplary embodiment essentially corresponds to the second exemplary embodiment, only the differences will be explained in detail below.

In contrast with the second exemplary embodiment, in the third exemplary embodiment, no bulges 23 and 24 are provided. Instead, in the third exemplary embodiment, a guide bush 20 is provided for guiding the tilting lever 3. Since the guide bush 20 can be easily prefabricated and can thereby satisfy tight tolerance requirements, the rigidity of the system can be improved even further. Otherwise, the third exemplary embodiment corresponds to the second exemplary embodiment, rendering further description superfluous.

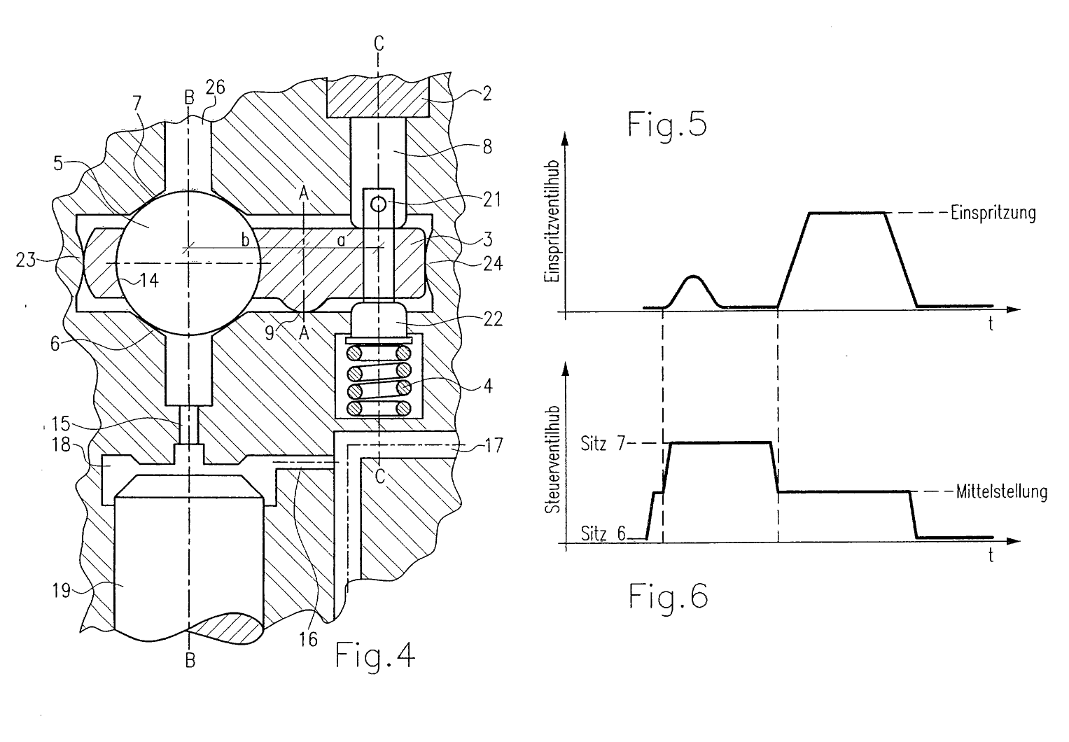

FIG. 4 shows a fluid control valve according to a fourth exemplary embodiment of the current invention. Parts that are the same or that function in the same manner have been provided with the same reference numerals as in the exemplary embodiments described above.

The fourth exemplary embodiment of the current invention is embodied as a double seat valve. A first valve seat 6 and a second valve seat 7 are provided, which can be opened and closed by a shared valve element 5.

As is shown in FIG. 4, the tilting lever 3 of the valve is provided with a through opening 14. A valve element 5, which is embodied as a ball, is fastened in this through opening 14, for example by means of a press fit. The tilting lever 3 is rotatably supported on a first bearing point 9. A helical spring 4 is once again provided as a restoring device, which acts on the tilting lever 3 by means of a piston 22. As is shown in FIG. 4, the spring 4 is disposed in such a way that it lies on a common axis C-C with a piston 8, which transmits the stroke of the piezoelectric actuator 2 to the tilting lever 3. As in the above examples, the lever ratio is once again a:b.

In addition, two protruding bulges 23 and 24 are provided in the housing, which serve to guide the tilting lever 3.

When closed, the valve is closed against the seat 6. When the piezoelectric actuator 2 is actuated, the tilting lever 3 moves the valve counter to the force of the spring 4, from the valve seat 6 to the valve seat 7 so that the valve seat 7 is closed. Through retraction of the piezoelectric actuator 2 by means of a prestressing spring (not shown), the tilting lever 3 is lifted back up from the seat 7 by a tension band 9, which is attached to the piston 8 and encompasses the right lever arm of the tilting lever 3 in a U-shape, so that a continuous opening is produced from a line 26 to a control chamber 18. As a result, a fluid can flow from the control chamber 18 to the line 26, so that a vacuum is produced in the control chamber 18 and the control piston 19 moves toward the valve ball 5 and e.g. a valve needle connected to the control piston 19 is lifted up from its seat in order to permit a fuel injection. The valve 1 is restored again by the spring 4 so that the ball 5 once again rests against the seat 6.

FIGS. 5 and 6 plot the stroke of the control valve 1 (FIG. 6) and the stroke of the injection valve (FIG. 5) over time. As is shown in FIG. 6, in the initial position of the valve 1, the seat 6 is closed. If the piezoelectric actuator 2 is activated, then the valve 1 temporarily closes against the seat 7, and then, based on the restoring of the piezoelectric actuator explained above, the valve assumes a middle position between the seat 6 and the seat 7, in which a vacuum acts on the control piston 19. As a result of this vacuum, the needle valve of the injection valve opens while the control valve is in the middle position, as shown in FIG. 5, in order to inject fuel into a combustion chamber. After deactivation of the piezoelectric actuator 2, the control valve assumes its normal position against the valve seat 6 once more, which also causes the injection of fuel to be terminated (see FIGS. 5 and 6).

In FIG. 5, before the actual injection, a small needle stroke is also shown, which theoretically occurs in the time between the opening of the valve seat 6 and the closing of the valve seat 7. Due to the inertias in the system, however, experience has shown this to be insignificant, particularly since the switching times of the control valve are also very short.

Consequently, the current invention relates to a fluid control valve. The valve includes a piezoelectric actuator 2, a stroke increasing mechanism 3, which increases the stroke of the piezoelectric actuator 2, a restoring element 4, and a valve element 5. The stroke increasing mechanism is embodied as a tilting lever 3 and the valve element 5 is integrated into the tilting lever, which produces a high degree of system rigidity with a minimum number of parts.

The above description of exemplary embodiments according to the current invention serves only as illustrations of the invention and not as a limitations thereto. Various alterations and modifications are possible without going beyond the scope of the invention and its equivalents.

1. A fluid control valve with a piezoelectric actuator (2), a stroke increasing mechanism for increasing a stroke of the piezoelectric actuator (2), a restoring element (4), and a valve element (5), characterized in that the stroke increasing mechanism is embodied as a tilting lever (3), and the valve element (5) is integrated into the tilting lever (3).

2. The fluid control valve according to claim 1, characterized in that the tilting lever (3) and the valve element (5) are embodied of one piece.

3. The fluid control valve according to claim 1, characterized in that the valve element (5) is embodied as a ball.

4. The fluid control valve according to one of claims 1 to 3, characterized in that the tilting lever (3) has a recess (11) for containing the valve element (5).

5. The fluid control valve according to one of claims 1 to 4, characterized in that the restoring element (4) engages the tilting lever (3) directly.

6. The fluid control valve according to one of claims 1 to 5, characterized in that the stroke increasing mechanism is disposed in a guide bush (20).

7. The fluid control valve according to one of claims 1 to 6, characterized in that the valve element (5) is embodied as a double seat valve.

8. The fluid control valve according to claim 7, characterized in that the tilting lever (3) is connected to the piezoelectric actuator (2) by means of a tension band (21).

9. The fluid control valve according to claim 7 or 8, characterized in that the tilting lever (3) is provided with a through opening (14), which contains a separate valve element (5).

10. A use of a fluid control valve according to one of claims 1 to 9 in an injection device for a common rail system.
